(19) United States
(12) Patent Application Publication
(10) Pub. No.: US 2020/0025595 A1
(43) Pub. Date: Jan. 23, 2020

(54) SYSTEM, METHOD, AND PROGRAM FOR DISPLAYING SENSOR INFORMATION ON MAP

(71) Applicant: OPTiM Corporation, Saga-shi (JP)

(72) Inventor: Shunji SUGAYA, Tokyo (JP)

(21) Appl. No.: 15/749,906

(22) PCT Filed: Mar. 30, 2017
(86) PCT No.: PCT/JP2017/013265

§ 371 Date: Feb. 2, 2018

(51) Int. Cl. G01D 7/02; G06F 3/14; G06T 11/60; G06N 20/00

(52) U.S. Cl. CPC G01D 7/02; G06F 3/14; G06T 2200/24; G06N 20/00; G06T 11/60

(57) ABSTRACT

The present invention is to display sensor information on the map that detect a sensor located in an area specified on a map, collect and analyze the sensor information that the sensor acquires, and display the analysis result mapping on to the position of the sensor on the map. The present invention provides a system for displaying sensor information on a map, including: an acquisition unit that acquires the position of a sensor located in a predetermined place; a receiving unit that receives an area specified on a map; a detection unit that detects a sensor located in the specified area; a collection unit that collects sensor information that the detected sensor acquires; an analysis unit that analyzes the collected sensor information; and a display unit that displays the analysis result mapping on to the position on the map.

### TECHNICAL FIELD

The present invention relates to a system, a method, and a program for displaying sensor information on a map.

### BACKGROUND ART

In recent years, sensors have spread, and a movement to use the acquired sensor information in various fields has been taking place. For example, the system that saves mapping sensor information on a geographic information system, leaving the mechanism of the sensor chip unchanged is provided (Patent Document 1).

### CITATION LIST

### Patent Literature

Patent Document 1: JP 2005-64562A

### SUMMARY OF INVENTION

However, the device of Patent Document 1 has a problem of not displaying what kind of sensor is located in the area specified on a map and what analysis result is to be obtained from the sensor information acquired from the sensor.

In view of the above-mentioned problems, an objective of the present invention is to provide a system, a method, and a program for displaying sensor information on a map that detect a sensor located in an area specified on a map, collect and analyze the sensor information that the sensor acquires, and display the analysis result mapping on to the position of the sensor on the map.

The first aspect of the present invention provides a system for displaying sensor information on a map, including:

an acquisition unit that acquires the position of a sensor located in a predetermined place;

a receiving unit that receives an area specified on a map;

a detection unit that detects a sensor located in the specified area;

a collection unit that collects sensor information that the detected sensor acquires;

an analysis unit that analyzes the collected sensor information; and

a display unit that displays the analysis result mapping on to the position on the map.

The first aspect of the present invention provides a method for displaying sensor information on a map, including the steps of;

acquiring the position of a sensor located in a predetermined place;

receiving an area specified on a map;

detecting a sensor located in the specified area;

collecting sensor information that the detected sensor acquires;

analyzing the collected sensor information; and

displaying the analysis result mapping on to the position on the map.

The first aspect of the present invention provides a program for causing a computer to execute the steps of;

acquiring the position of a sensor located in a predetermined place;

receiving an area specified on a map;

detecting a sensor located in the specified area;

collecting sensor information that the detected sensor acquires;

analyzing the collected sensor information; and

displaying the analysis result mapping on to the position on the map.

According to the present invention, what kind of sensor is located in the area specified on a map and what analysis result is to be obtained from the sensor information acquired from the sensor are displayed.

### BRIEF DESCRIPTION OF DRAWINGS

FIG. 1 shows a schematic diagram of the system for displaying sensor information on a map.

FIG. 2 shows one example that displays sensor information on a map.

Embodiments of the present invention will be described below. However, this is illustrative only, and the technological scope of the present invention is not limited thereto.

The system for displaying sensor information on a map of the present invention displays sensor information on the map. The types of the sensor are not limited in particular. The sensor may be a temperature sensor, a distortion sensor, an ultrasonic sensor, or any other sensor.

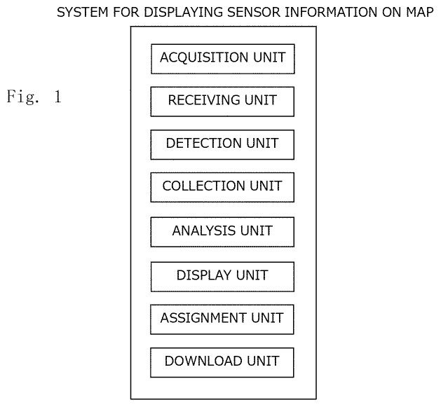

A preferable embodiment of the present invention will be described below with reference to FIG. 1. FIG. 1 shows a schematic diagram of the system for displaying sensor information on a map according to a preferable embodiment of the present invention.

As shown in FIG. 1, the system for displaying sensor information on a map includes an acquisition unit, a receiving unit, a detection unit, a collection unit, an analysis unit, and a display unit that are achieved when the control unit reads a predetermined program. The system may also include an assignment unit and a download unit. These units may be of an application type, a cloud type, or any other type. The above-mentioned units may each be achieved by a single computer or two or more computers (e.g., a server and a terminal).

The acquisition unit acquires the position of a sensor located in a predetermined place. The position may be acquired from GPS installed in the sensor. If the sensor actively transmits information on the position, the information only has to be received to acquire the position. If the sensor is passive, the information may be acquired by accessing the sensor. The position may be represented by a latitude and longitude, an address, or anything.

The receiving unit receives an area specified on a map. The area may be specified by drawing lines freehand on a map with the touch panel, the mouse, etc. Alternatively, the area may be specified from an address such as Tokyo Minato Ward on a map. Alternatively, the area may be specified from a longitude and latitude on a map. For example, the area is the factory if a factory is specified on the map, and the area is the field if a field is specified on the map.

The detection unit detects a sensor located in the specified area. The sensor can be detected by comparing the position of the sensor that the acquisition unit acquires with the specified area that the receiving unit receives. For example, if the specified area that the receiving unit receives is Tokyo Minato Ward, a sensor located in Tokyo Minato Ward will be detected.

Alternatively, the receiving unit may receive the area specified on a map and information on whether or not to include a sensor located on the borderline of the area as a detection target. Then, the detection unit may detect a sensor included as a detection target that is located in the specified area. If there is a sensor located on the borderline of the area, the receiving unit preferably receives information on whether or not to include a sensor located on the borderline of the area as a detection target. Thus, whether or not to include a sensor located on the borderline of the area as a detection target can be selected.

The collection unit collects sensor information that the detected sensor acquires. The sensor information may be collected only for a predetermined period. For example, if the sensor information for past five years is important, the sensor information is previously determined to be collected for past five years. The collection period may be determined for each sensor or commonly determined for all the sensors. Furthermore, the collection period may be determined depending on the type of the sensor. This provides an advantage to make the analysis of the sensor information easy.

The analysis unit analyzes the collected sensor information. The collected sensor information may not be beneficial as it is. Thus, the collected sensor information is analyzed to change into beneficial information. The analysis unit may learn sensor information collected in the past as teacher data by the machine learning and analyze the sensor information that the collection unit corrects. The analysis performed by artificial intelligence through machine learning enables prediction, clustering, and others. For example, sensor information on the temperature of plant machinery that the sensor measures is analyzed to enable the fault prediction, etc., of a machine. For another example, images taken by a network camera are analyzed to enable the identification of the figure properties, etc. The machine learning enables various other actions.

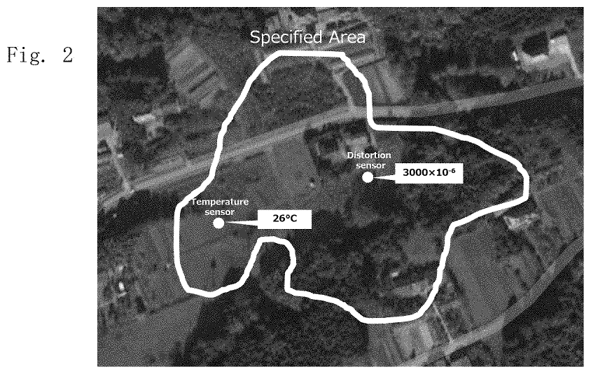

The display unit displays the analysis result mapping on to the position of the sensor on a map. For example, if the sensor is located on 35° 39′ 25″ north latitude and 139° 45′ 34″ east longitude, the analysis result is displayed on the point of 35° 39′ 25″ north latitude and 139° 45′ 34″ east longitude on a map. For example, if the sensor is located at 1-2-20, Kaigan, Minato-ku, Tokyo, the analysis result is displayed at 1-2-20, Kaigan, Minato-ku, Tokyo on a map. FIG. 2 shows one analysis result including a temperature of 26° C. from a temperature sensor and the degree of distortion of 3000×10⁻⁶ from a distortion sensor that are displayed as one example. However, if the number of analysis results is two or more, all or the most appropriate one of the analysis results may be displayed.

Furthermore, the display unit may display the analysis result and the type of the sensor that map on to the position of the sensor on a map. For example, as shown in FIG. 2, if a temperature sensor and a distortion sensor that are located in the area specified by a white line are detected, the types: a temperature sensor and a distortion sensor and the analysis results: a temperature and the degree of distortion that map on to the position of the respective sensors are displayed on a map. Accordingly, the present invention has more remarkable effect.

Furthermore, the display unit may change and display the attention degree according to the type of the sensor. For example, in FIG. 2, the colors of the balloons from the temperature sensor and the distortion sensor are red and blue, respectively. Not only the color but also the shape, the size, etc. may be changed. Accordingly, the present invention has more remarkable effect.

The assignment unit assigns a uniform resource locator (hereinafter referred to as “URL”) to the displayed sensor information. The download unit enables the download of the displayed sensor information when the URL is accessed. This makes the sensor information more useful. For example, in FIG. 2, a URL that links to the character string “26 degrees Celsius” is built. By accessing this link, the information indicating 26 degrees Celsius can be downloaded. This is more convenient for two or more kinds of sensor information displayed, in particular.

### Process Behavior

The method for displaying sensor information on a map will be described below. The method for displaying sensor information on a map displays sensor information on the map.

The method for displaying sensor information on a map at least includes an acquisition step, a receiving step, a detection step, a collection step, an analysis step, and a display step. The method may also include an assignment step and a download step.

In the acquisition step, the acquisition unit acquires the position of the sensor from each sensor. The position may be acquired from GPS installed in the sensor. If the sensor actively transmits information on the position, the information only has to be received to acquire the position. If the sensor is passive, the information may be acquired by accessing the sensor. The position may be represented by a latitude and longitude, an address, or anything.

In the receiving step, the receiving unit receives an area specified on the map in response to input from the user. The area may be specified by drawing lines freehand on a map with the touch panel, the mouse, etc. Alternatively, the area may be specified from an address such as Tokyo Minato Ward on a map. Alternatively, the area may be specified from a longitude and latitude on a map. For example, the area is the factory if a factory is specified on the map, and the area is the field if a field is specified on the map.

In the detection step, the detection unit detects a sensor located in the specified area. The sensor can be detected by comparing the position of the sensor acquired in the acquisition step with the specified area received in the receiving step. For example, if the specified area received in the receiving step is Tokyo Minato Ward, a sensor located in Tokyo Minato Ward will be detected.

Alternatively, in the receiving step, the receiving unit may receive the area specified on a map and information on whether or not to include a sensor located on the borderline of the area as a detection target. Then, the detection step may detect a sensor included as a detection target that is located in the specified area. If there is a sensor located on the borderline of the area, the receiving unit preferably receives information on whether or not to include a sensor located on the borderline of the area as a detection target. Thus, whether or not to include a sensor located on the borderline of the area as a detection target can be selected.

In the collection step, the collection unit collects sensor information (data including values) that the detected sensor acquires. The sensor information may be collected only for a predetermined period. For example, if the sensor information for past five years is important, the sensor information is previously determined to be collected for past five years. The collection period may be determined for each sensor or commonly determined for all the sensors. Furthermore, the collection period may be determined depending on the type of the sensor. This provides an advantage to make the analysis of the sensor information easy.

In the analysis step, the analysis unit analyzes the collected sensor information. The collected sensor information may not be beneficial as it is. Thus, the collected sensor information is analyzed to change into beneficial information. The analysis step may learn sensor information collected in the past as teacher data by the machine learning and analyze the sensor information that the collection unit corrects. The analysis performed by artificial intelligence through machine learning enables prediction, clustering, and others. For example, sensor information on the temperature of plant machinery that the sensor measures is analyzed to enable the fault prediction, etc., of a machine. For another example, images taken by a network camera are analyzed to enable the identification of the figure properties, etc. The machine learning enables various other actions.

In the display step, the display unit displays the analysis result mapping on to the position of the sensor on a map. For example, if the sensor is located on 35° 39′ 25″ north latitude and 139° 45′ 34″ east longitude, the analysis result is displayed on the point of 35° 39′ 25″ north latitude and 139° 45′ 34″ east longitude on a map. For example, if the sensor is located at 1-2-20, Kaigan, Minato-ku, Tokyo, the analysis result is displayed at 1-2-20, Kaigan, Minato-ku, Tokyo on a map. FIG. 2 shows one analysis result including a temperature of 26° C. from a temperature sensor and the degree of distortion of 3000×10⁻⁶ from a distortion sensor that are displayed as one example. However, if the number of analysis results is two or more, all or the most appropriate one of the analysis results may be displayed.

Furthermore, in the display step, the display unit may display the analysis result and the type of the sensor that map on to the position of the sensor on a map. For example, as shown in FIG. 2, if a temperature sensor and a distortion sensor that are located in the area specified by a white line are detected, the types: a temperature sensor and a distortion sensor and the analysis results: a temperature and the degree of distortion that map on to the position of the respective sensors are displayed on a map. Accordingly, the present invention has more remarkable effect.

Furthermore, in the display step, the display unit may change and display the attention degree according to the type of the sensor. For example, in FIG. 2, the colors of the balloons from the temperature sensor and the distortion sensor are red and blue, respectively. Not only the color but also the shape, the size, etc. may be changed. Accordingly, the present invention has more remarkable effect.

In the assignment step, the assignment unit assigns a URL to the displayed sensor information. The download step enables the download of the displayed sensor information when the URL is accessed. This makes the sensor information more useful. For example, in FIG. 2, a URL that links to the character string “26 degrees Celsius” is built. By accessing this link, the information indicating 26 degrees Celsius can be downloaded. This is more convenient for two or more kinds of sensor information displayed, in particular.

To achieve the means and the functions that are described above, a computer (including a CPU, an information processor, and various terminals) reads and executes a predetermined program. For example, the program may be an application installed in a computer, may be provided through Software as a Service (SaaS), specifically, from a computer through a network, or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

As the specific algorithm of the above-mentioned machine learning, the nearest neighbor algorithm, the naive Bayes algorithm, the decision tree, the support vector machine, the reinforcement learning, etc., may be used. Furthermore, the machine learning may be the deep learning that generates the feature amount for learning by using the neural network.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

1. A system for displaying sensor information on a map, comprising:
an acquisition unit that acquires the position of a sensor located in a predetermined place;
a receiving unit that receives an area specified on a map;
a detection unit that detects a sensor located in the specified area;
a collection unit that collects sensor information that the detected sensor acquires;
an analysis unit that analyzes the collected sensor information; and
a display unit that displays the analysis result mapping on to the position on the map,
wherein the receiving unit receives the area specified on a map and information on whether or not to include a sensor located on the borderline of the area as a detection target, and the detection unit detects a sensor included as a detection target that is located in the specified area.

2. The system according to claim 1, wherein the acquisition unit acquires the position of the sensor from GPS installed in the sensor.

3. The system according to claim 1, wherein the receiving unit receives an area specified by drawing lines freehand on the map.

4. (canceled)

5. The system according to claim 1, wherein the collection unit collects sensor information that the detected sensor acquires only for a predetermined period.

6. The system according to claim 1, wherein the analysis unit learns sensor information collected in the past as teacher data by the machine learning and analyzes the sensor information that the collection unit corrects.

7. The system according to claim 1, wherein the display unit displays the analysis result and the type of the sensor that map to on the position of the sensor on the map.

8. The system according to claim 1, wherein the display unit changes and displays the attention degree according to the type of the sensor.

9. The system according to claim 1, further comprising:
an assignment unit that assigns a uniform resource locator to the displayed sensor information; and
a download unit that enables the download of the displayed sensor information when the uniform resource locator is accessed.

10. A method for displaying sensor information on a map, comprising the steps of:
acquiring the position of a sensor located in a predetermined place;
receiving an area specified on a map;
detecting a sensor located in the specified area;
collecting sensor information that the detected sensor acquires;
analyzing the collected sensor information; and
displaying the analysis result mapping on to the position on the map,
wherein receiving the area includes receiving the area specified on a map and information on whether or not to include a sensor located on the borderline of the area as a detection target, and the detecting the sensor includes detecting a sensor included as a detection target that is located in the specified area.

11. A computer program product, comprising a non-transitory computer usable medium having a set of instructions physically embodied therein, the set of instructions including computer readable program code, which when executed by the system causes a computer to execute the steps of:
acquiring the position of a sensor located in a predetermined place;
receiving an area specified on a map;
detecting a sensor located in the specified area;
collecting sensor information that the detected sensor acquires;
analyzing the collected sensor information; and
displaying the analysis result mapping on to the position on the map,
wherein receiving the area includes receiving the area specified on a map and information on whether or not to include a sensor located on the borderline of the area as a detection target, and the detecting the sensor includes detecting a sensor included as a detection target that is located in the specified area.
